(19) United States
(12) Patent Application Publication
(10) Pub. No.: US 2003/0187779 A1
(43) Pub. Date: Oct. 2, 2003

(54) Business method for intermediating the things by loan of use using the network and computer readable medium having stored thereon computer executable instruction for performing the method

(76) Inventor: Hun-Ju Han, Seoul (KR)

Correspondence Address: Welsh & Katz Ltd, 22nd Floor, 120 South Riverside Plaza, Chicago, IL, 60606, US

(21) Appl. No.: 10/362,302

(22) PCT Filed: Sep. 15, 2001
(86) PCT No.: PCT/KR01/01550

(30) Foreign Application Priority Data
Sep. 16, 2000 (KR) 200054414
Jun. 20, 2001 (KR) 200135208

(51) Int. Cl. G06F 17/60

(52) U.S. Cl. 705/38; 705/37

(57) ABSTRACT

The present invention relates to a business method for intermediating temporary exchange use or loan use of things using the network and computer readable medium having computer executable instruction for performing the method. The inventive business method comprises steps the user's registering things that he/she wants to temporarily exchange or loaning to the database of the business proprietor; the business proprietor's finding things corresponding to the condition by comparing information about things input by the users; the business proprietor's intermediating the exchange or loan of things between users; and the business proprietor's certifying the return of the things and compensating the user for damages.

### BACKGROUND OF THE INVENTION

(a) Field of the Invention

The present invention relates to a business method for intermediating temporary exchange or loan of things using the network and computer readable medium having computer executable instruction for performing the method, and more particularly, to a business method for intermediating temporary exchange or loan of things using the network in which, when a user lets a business proprietor know a thing that he/she wants to temporarily exchange or loan, a business proprietor finds a thing corresponding to a condition such as term of exchange or loan, etc the user desires by comparing information about things that users want to exchange or loan and intermediates the exchange or loan of things between users and computer readable medium having computer executable instruction for performing the method.

(b) Description of the Related Art

According to the conventional internet service business intermediating the barter, things that service users trade permanently belong to the other person of trade. Accordingly, when a thing to be trade requires processes of the law like automobile, it costs much because of tax such as a registration tax, an acquisition tax, etc and the issuance of various kinds of certificates and the processes are complicate. In addition, when a thing to be trade is a real estate, it may be cumbersome since the registration according to the processes of law should be made, plus, even when a user wants to use a real estate only temporarily, he/she should make the registration according to the processes of law to get the real estate and then should make the registration in response to re-transaction to return the same.

Further, the existing barter has some defects because users should exchange things in person. People tend to avoid exchanging things in person since exchanging things between people met for the first time could be risky and it is impossible to know in advance the condition of things. In another way, people can exchange things by using an appointed exchange center. However, this method also has some defects that users should appoint the time or a user that visits the center before the other user should visit the center twice as well as monetary matter. According to the existing barter, since the proprietary of things should be transferred, people generally do not want to exchange things that he/she loves even though the things are not presently used.

### SUMMARY OF THE INVENTION

It is an object of the present invention is to overcome the above-mentioned problems and for this, the present invention provides a business method for intermediating temporary exchange of things for the period of time stipulated with each other between users with/without compensation using the network.

It is another object of the present invention is to provide a business method for intermediating temporary loan to another user of a user's things that are not presently used and pre-deposited in the deposit center using the intermediating network.

It is another object of the present invention may be achieved by computer readable medium having computer executable instruction for performing the business method for intermediating exchange and loan of things using the network.

The first object of the present invention may be achieved a business method for intermediating temporary exchange of things using the network comprising steps: (a) building a database linked to a web server with personal information of users and information about things to be exchanged having fixed period of time of exchange; (b) searching the information of things to be exchanged input by the users for things having corresponding condition; (c) intermediating the exchange of things for the stipulated time under the acceptance of users; and (d) certifying whether the things return or not after the stipulated time by a business proprietor.

In accordance with the present invention, the (b) step further comprises a step informing users having things coinciding exchange conditions with each other of the result and said user's finding things that he/she wants by searching the database of said business proprietor and requesting the exchange of things to another user.

In accordance with the present invention, when the exchange is made among three users A, B, and C, the user A lends things to the user B, the user B lends things to the user C, and the user C lends things to the user A.

In accordance with the present invention, when the users A and B have a confidence relationship, the user A lends his/her things to the user C and the user C lends his/her things to the user B.

In accordance with the present invention, the business proprietor deposits things of the users in a predetermined place and makes out examination data of the conditions of things to be exchanged to allow the exchange use or the share of use.

In accordance with the present invention, the (d) step further comprising steps calculating the amount of damages by comparing the conditions before and after exchange of things and charging the user the amount of damages.

In accordance with the present invention, the things to be exchanged movable property or real estate.

In accordance with the present invention, the things to be exchanged belongs to one item or more selected among various kinds of valuable movable property or real estate such as housings, lands, automobiles, books, jewels, accessories, exhibits, machines, medical instruments, electronic products, programs including software, membership ticket, utilization ticket, etc.

In accordance with the present invention, the service of exchange use is made between users or between user and the business proprietor with or without compensation.

In accordance with the present invention, the service of exchange use is provided with compensation, the settlement method is one or more selected among cash, credit card, depositing without bankbook, electronic settlement, cyber money, and member point.

In accordance with the present invention, the comparing item to exchanging things is one or more selected among things that the users want to exchange, evaluation price, the desired period of time of exchange, and condition that the users desire.

In accordance with the present invention, the service business proprietor provides a new insurance related to temporary exchange without compensation through the insurance company when the business proprietor and the user make a contract with each other.

In accordance with the present invention, the database of the information of the users' things that the service business proprietor builds on the web comprises one or more selected among the information of things to be exchanged, the information of things in progress of exchange, the information of things to be returned, and the information of insurance of things.

In accordance with the present invention, the insurance company takes the main part of this business and provide said service.

The second object of the present invention may be achieved another business method for intermediating temporary exchange of things using the network comprising steps: (a) building a database linked to a web server with personal information of users and information about things to be exchanged; (b) receiving things of said users by way of donation, trust, or selling and depositing the same in a predetermined place; (c) lending said thing to another user for the stipulated time; and (d) returning said thing from said user who borrows the thing and calculating the amount of damages by checking the condition of thing by a business proprietor.

In accordance with the present invention, the things to be loaned is movable property or real estate, to be loaned belongs to one item or more selected among various kinds of valuable movable property or real estate such as housings, lands, automobiles, books, jewels, accessories, exhibits, machines, medical instruments, electronic products, programs including software, membership ticket, utilization ticket, etc.

In accordance with the present invention, the service of loan use is made between users or between user and the business proprietor with or without compensation.

In accordance with the present invention, the service of loan use is provided with compensation, the settlement method is one or more selected among cash, credit card, depositing without bankbook, electronic settlement, cyber money, and member point.

The Third object of the present invention may be achieved by computer readable medium having computer executable instruction for performing the business method for intermediating loan of things using the network. For example, ROM (Read Only Memory), RAM (Random Access Memory), CD (Compact Disk)-Rom, DVD (Digital Video Disk)-Rom, magnetic tape, floppy disk, hard disk, optical data storage device, etc. may be mentioned. Further, something implemented in the form of carrier wave (for example, transmission through internet) is also included. In addition, in such a writing medium, code that is dispersed in computer systems connected by network and that the computer can read in dispersed way may be stored and executed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or the similar components, wherein:

FIG. 1 is a network structural diagram of business method for intermediating temporary exchange of things using the network according to the present invention;

FIG. 2 is a network structural diagram of business method for intermediating loan of things using the network according to the present invention;

FIG. 3 is a network structural diagram of service that an insurance company is a main part of according to an embodiment of the present invention;

FIG. 4 is a structural diagram showing a method for exchanging or loaning things using a things deposit center according to an embodiment of the present invention;

FIG. 5 is a structural diagram showing a method for jointly using a things deposit center according to an embodiment of the present invention;

FIG. 6a is a structural diagram showing a method for temporary exchange of things among multiple users according to an embodiment of the present invention;

FIG. 6b is a structural diagram showing a method for temporary exchange of things among multiple users on the basis of confidence relationship according to an embodiment of the present invention;

FIG. 7 is a diagram showing a database of information of user's articles that a business proprietor builds on its server according to an embodiment of the present invention;

FIG. 8 is a diagram showing a database of personal information of member that a business proprietor builds on its server according to an embodiment of the present invention;

FIG. 9 is a flow chart showing intermediation service for temporary exchange of things using the network according to the present invention;

FIG. 10 is a procedure diagram showing searching, requesting, and accepting processes between users according to an embodiment of the present invention;

FIG. 11 is a drawing showing a web page for registering data of a user's articles according to an embodiment of the present invention;

FIG. 12 is a drawing of a web page for showing a list that users register thereto according to an embodiment of the present invention;

FIG. 13 is a drawing of a web page for showing an application for housing service according to an embodiment of the present invention;

FIG. 14 is a drawing of a web page for showing an application for automobile according to an embodiment of the present invention;

FIG. 15 is a diagram showing insurance matters required for exchange of automobiles according to an embodiment of the present invention;

FIG. 16 is a structural diagram of service concerned with books according to an embodiment of the present invention; and

FIG. 17 is a structural diagram of service concerned with jewels and accessories.

### DETAILED DESCRIPTION OF THE PREFERRED EMBODIMENTS

The detailed description of the present invention referring to the experimental examples and embodiments is provided hereinafter. However, the embodiments according to the present invention can be modified in various ways and the claims of the present invention should not be understood to be restricted to the embodiments described below. The embodiments of the present invention are provided to more clearly and easily describe the present invention to a person who has standard knowledge in this technical area. In drawings, the identified references designate the identified elements.

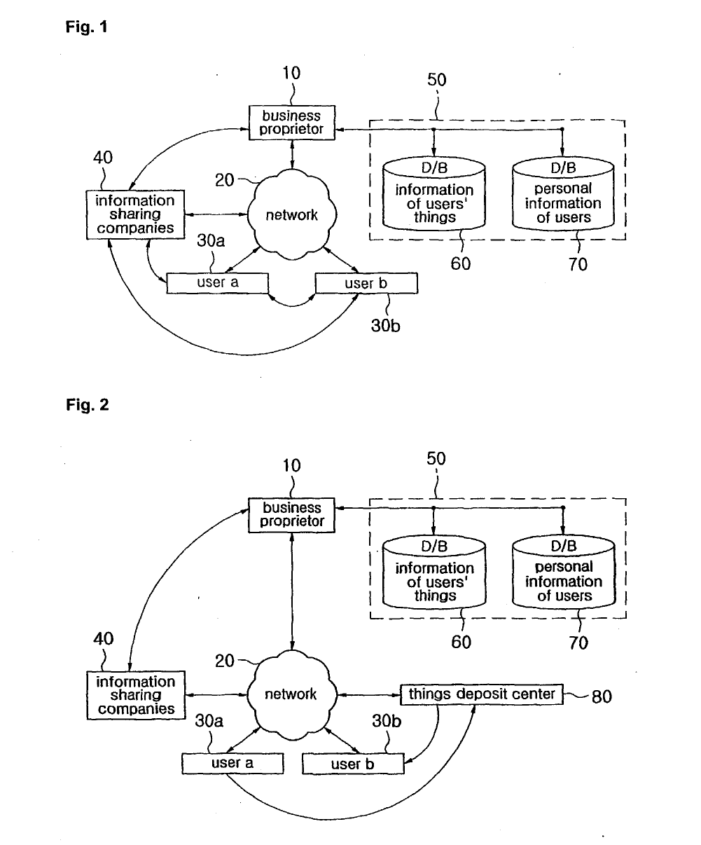

FIG. 1 is a network structural diagram of business method for intermediating temporary exchange of things using the network according to the present invention.

According to FIG. 1, service users 30a and 30b can access a main server 50 of a service business proprietor 10 through the network 20 and the main server 50 of the service business proprietor 10 has database 60 of articles information of users and database 70 of personal information of members. It is preferable that the business proprietor 10 cooperates with information sharing companies 40 and shares database of the information sharing companies 40 through the network 20 for smooth proceeding of service.

The information sharing companies 40 should be authenticated ones to obtain information about insurance, accident dealing, and settlement for provision of service with compensation and personal information, etc. required for service proceeding. The information sharing companies 40 may be subsidiary organizations of government, insurance companies, Korean non life insurance association, the police agency, the financial supervisory service, and various kinds of companies related to finance securing strategic and business cooperation of the service business proprietor 10.

The network 20 for transferring data among the service business proprietor 10, the users 30, and the information sharing companies 40 includes LAN (Local Area Network), WAN (Wide Area Network), internet, intranet, PSTN (Public Switched Telephone Network), WWW (World Wide Web), FTP (File Transfer Protocol), and mail. In addition, the conventional communication system such as telephone or facsimile, IMT2000, or PDA may be used.

Referring to FIG. 1, the users 30a and 30b register as members when they first access the main server 50 of the business proprietor 10 through the network 20, become regular members through authentication by the information sharing companies 40, and the information is stored in the database 70 of personal information of the business proprietor. The users 30, after registration as members, input information of articles of their own for the service. The information of the articles is stored in the database 60 of the users' articles of the business proprietor.

FIG. 2 is a network structural diagram of business method for intermediating loan of things using the network according to the present invention.

Referring to FIG. 2, the user a 30a accesses the server of the business proprietor 10 through the network 20, inputs information of an article to be deposited, and deposits the article in a things deposit center 80. The business proprietor manages the article deposited in the things deposit center 80 and lends the article through the things deposit center 80 when the user b 30b searches the article he/she wants to borrow and requests the loan of the article through the server of the business proprietor 10.

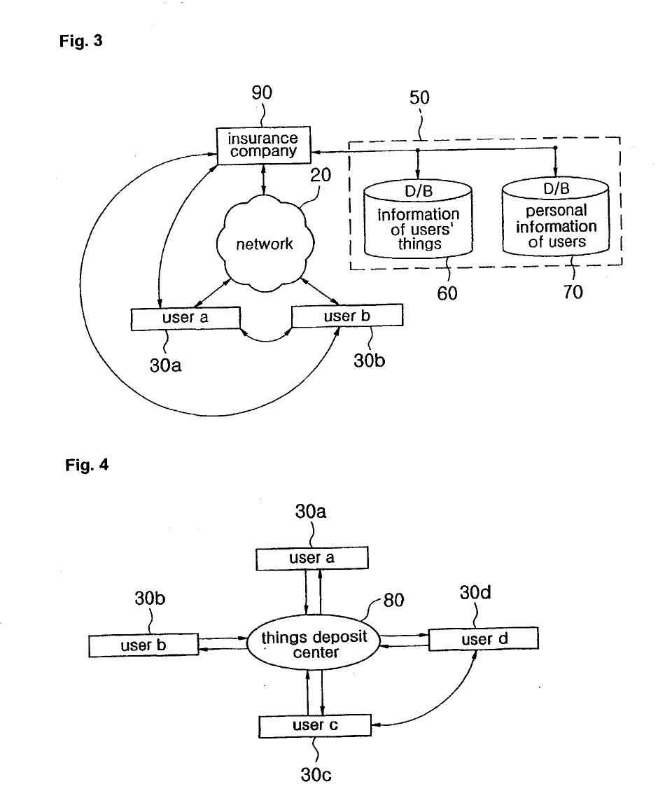

FIG. 3 is a network structural diagram of service that an insurance company is a main part of according to an embodiment of the present invention;

Referring to FIG. 3, since an insurance company 90 takes the main part of the service business, the database 60 of the information of the users' articles and the database 70 of the personal information built by the business proprietor in FIG. 1 are built in a server 50 belonging to the insurance company 90. The users 30a and 30b can access the server of the insurance company 90 through the network 20.

FIG. 4 is a structural diagram showing a method for exchanging or loaning things using a things deposit center according to an embodiment of the present invention.

Referring to FIG. 4, users 30a, 30b, 30c, and 30d may use the things deposit center 80 when they temporarily exchange or loan things. In case of the loan of things, the user a 30a donates, entrusts, or sells an article that he/she does not need to the things deposit center 80. The user b 30b searches the information about articles deposited in the things deposit center 80 and borrows an article that he/she wants from the things deposit center 80.

Further, in case of the temporary exchange of things, the user c 30c and the user d 30d may exchange things in person or by depositing things in the things deposit center 80. In case of using the things deposit center 80, the users 30c and 30d do not need to appoint a time and a place to meet each other and the business proprietor checks the conditions of articles deposited in the things deposit center 80 and stores the information about the conditions thereof. In addition, the business proprietor 10 entrusted with the disposal of the articles that the users 30 deposit in the things deposit center 80 by the users 30 may let the articles to be exchanged or loaned by any other users 30. That means that a multiplicity of users 30 can share the deposited articles.

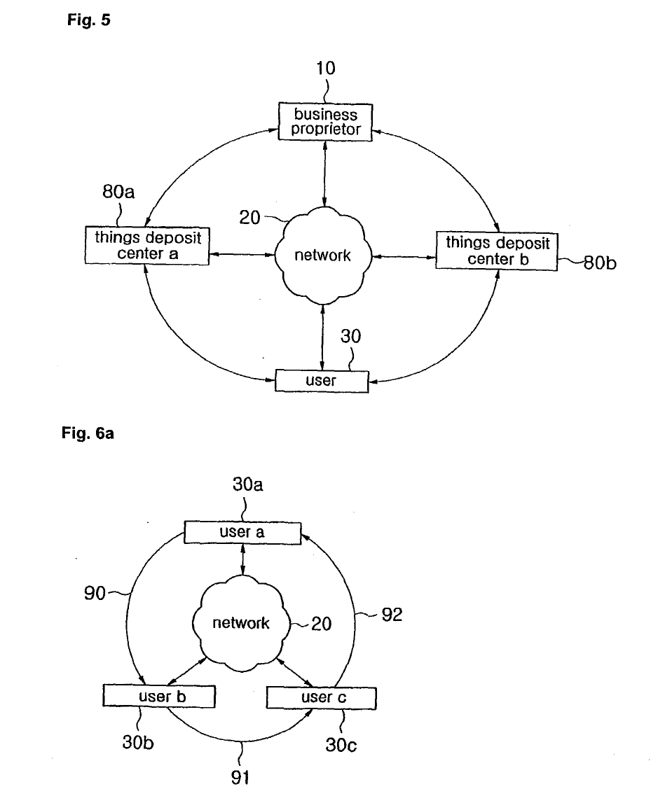

FIG. 5 is a structural diagram showing a method for jointly using a things deposit center according to an embodiment of the present invention.

Referring to FIG. 5, the users 30 who deposits articles in a things deposit center a 80a may exchange or borrow articles not only in a things deposit center a 80a but also in the things deposit center a 80a. The multiple things deposit centers 80 cooperate with each other and share the information about deposited articles through the network 20. The users 30 may find a things deposit center 80 having articles that the users 30 need by the information search and may temporarily exchange or borrow the articles from the nearest things deposit center 80. In addition, when the service is without compensation, the users who provide articles may receive point or something according to the loan results of the articles deposited in the thing deposit center a 80a.

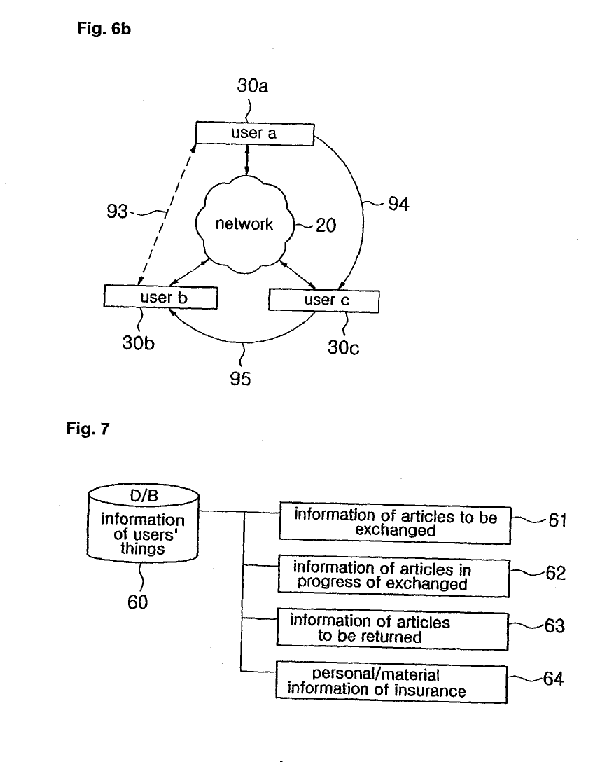

FIG. 6a is a structural diagram showing a method for temporary exchange of things among multiple users according to an embodiment of the present invention.

FIG. 6a, shows the intermediation service for temporary exchange of things among multiple users more than three. This is another form of this service. Referring to FIG. 6a, in case that the users are three, i.e., user a, user b, and user c, the user a 30a lends the user b 30b a thing that the user b 30b needs (90), the user b 30b lends the user c 30c a thing that the user c 30c needs (91), and the user c 30c lends the user a 30a a thing that the user a 30a needs (92). In this case, it is not the exchange between the user a 30a and the user b 30b. Such service may be useful when the users who reside in different countries from each other temporarily stay in foreign countries and want to loan or exchange things or when the articles that each of the users needs do not coincide with each other.

FIG. 6b is a structural diagram showing a method for temporary exchange of things among multiple users on the basis of confidence relationship according to an embodiment of the present invention.

Referring to FIG. 6b, in case that the users a 30a and b 30b have confidence relationship or acquaintance with each other (93), the user a 30a temporarily lends a thing to the user c 30c (94) and the user c 30c temporarily lends a thing to the user b 30b (95). This is another form of this service. Such a method may be used when the articles that the users a 30a and c 30c need do not coincide with each other. The user c 30c who needs the article of the user a 30a borrows the thing from the user a 30a (94) and the user b 30b who needs the article of the user c 30c and has acquaintance with the user a 30a borrows the thing from the user c 30c (95).

FIG. 7 is a diagram showing a database of information of user's articles that a business proprietor builds on its server according to an embodiment of the present invention.

Referring to FIG. 7, the database 60 of the information about the users' articles built by the service business proprietor 10 is preferably formed of a field 61 of articles to be exchanged, a field 62 of articles in progress, a field 63 of articles to be returned, and a field 64 of insurance information of articles and it is reasonable that another fields may be added when required.

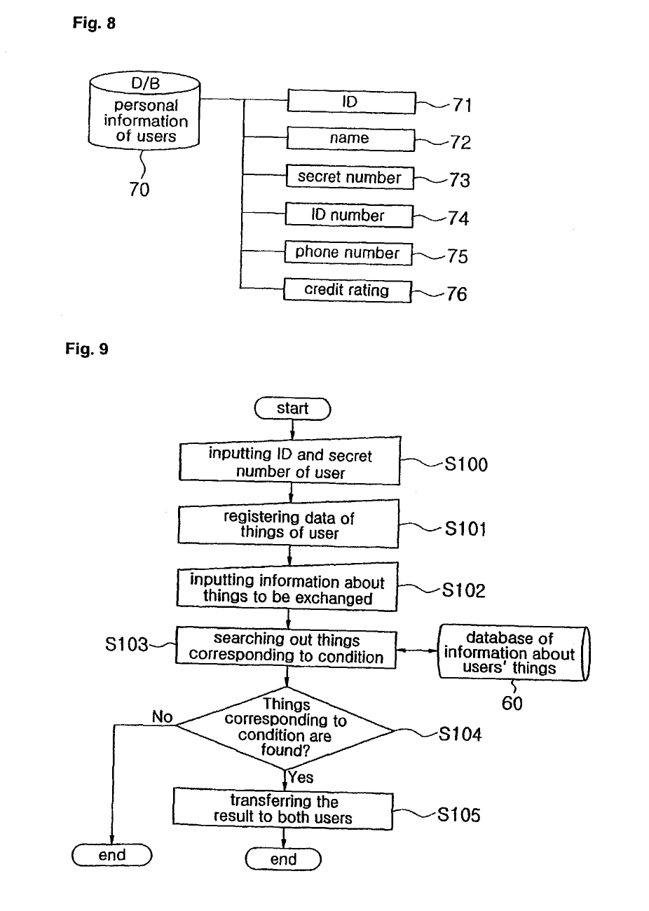

FIG. 8 is a diagram showing a database of personal information of member that a business proprietor builds on its server according to an embodiment of the present invention.

Referring to FIG. 8, the database 70 of the personal information is preferably formed of ID 71, name 72, secret number 73, ID number 74, phone number 75, credit rating 76, etc. and it is reasonable that another fields may be added when required.

FIG. 9 is a flow chart showing intermediation service for temporary exchange of things using the network according to the present invention.

Referring to FIG. 9, the users 30 access a web page of the business proprietor 10 and input ID and password to log in for receiving the service. When the log-in is successfully made, the users 30 register the information of their articles (S11) and input the information of the articles that they want to temporarily exchange (S102). The business proprietor 10 searches data of the database 60 of the information about the input users' articles (S103) and compares the information of the articles to be exchanged input by the users 30 (S104). When the articles corresponding to the users' needs are found, the business proprietor transfers the result to the both users 30a and 30b (S105).

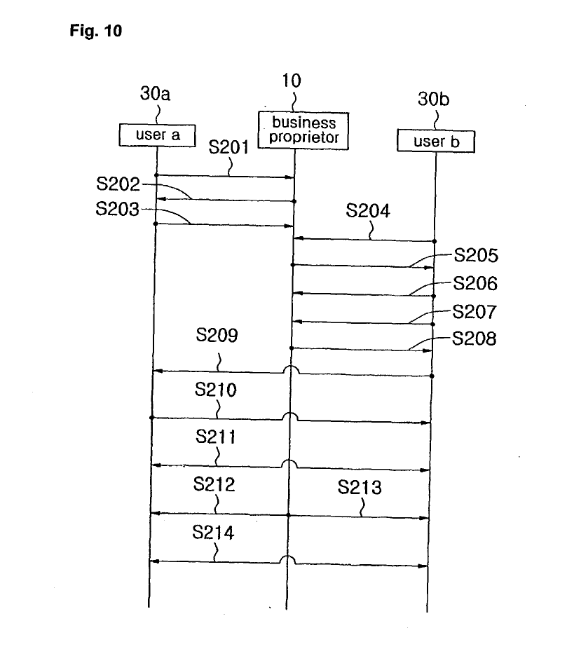

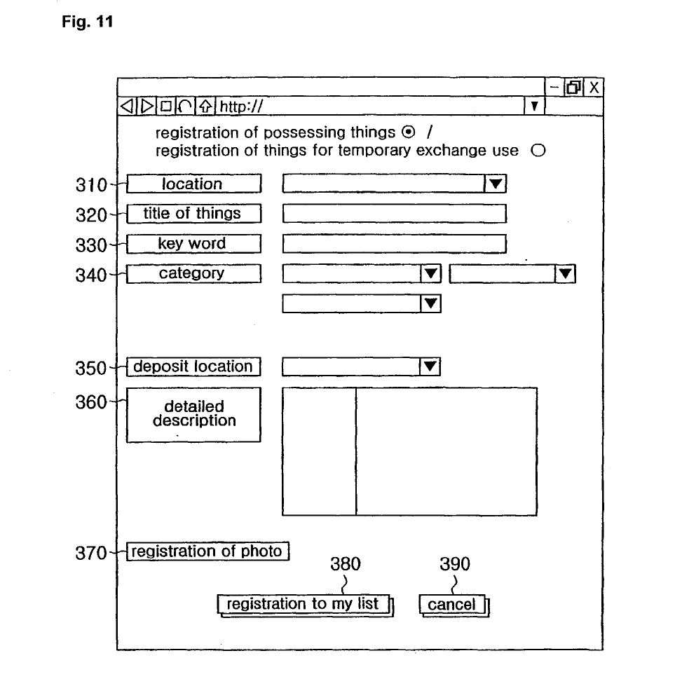

FIG. 10 is a procedure diagram showing searching, requesting, and accepting processes between users according to an embodiment of the present invention.

Referring to FIG. 10, the user a 30a accesses the server of the business proprietor and makes log-in to receive the service (S201). When the business proprietor 10 certifies that the user 30 is a member by the input personal information (S202), the user 30 inputs the information of articles of his/her own (S203). The user b 30b also makes log-in in the same way that of the user a 30a (S204 and S205) and inputs the information of articles of his/her own (S206). The user b 30b searches the required articles in the different way from that described in FIG. 9. The user b 30b searches the database 60 of the articles information of the business proprietor and finds articles corresponding to the needs of the user b 30b (S207) and the business proprietor 10 provides the search result to the user b 30b (S208). The user b 30b chooses one from the searched articles and requests the exchange to the user a 30a who has the article that he/she wants to temporarily exchange with adding conditions that the user b 30b desires (S209). The user a 30a who receives the request of temporary exchange of articles certifies the request proposed by the user b 30b and gives an acceptance notice to the user b 30b when the user a 30a wants to exchange the articles with the user b 30b (S210). The users a and b 30a and 30b exchange the articles through the things deposit center 80 or in person (S211). When the stipulated time is expired, the business proprietor 10 notices that fact to the users a and b 30a and 30b and requests the return of the articles (S212 and S213). When the users a and b 30a and 30b return the used articles to each other (S214), the service is terminated.

FIG. 11 is a drawing showing a web page for registering data of a user's articles according to an embodiment of the present invention.

Referring to FIG. 11, the user 30 registers an article belongs to him/her and an article that he/she wants to use by temporary exchange. The user 30 writes or selects the location 310, the title of the article 320, the key word 330, the category 340, the deposit location 350, the detailed description 360, etc. and registers the photo 370 of the article. When all the required information is input, the information is registered to ‘my list’ 380 or may be canceled and re-input.

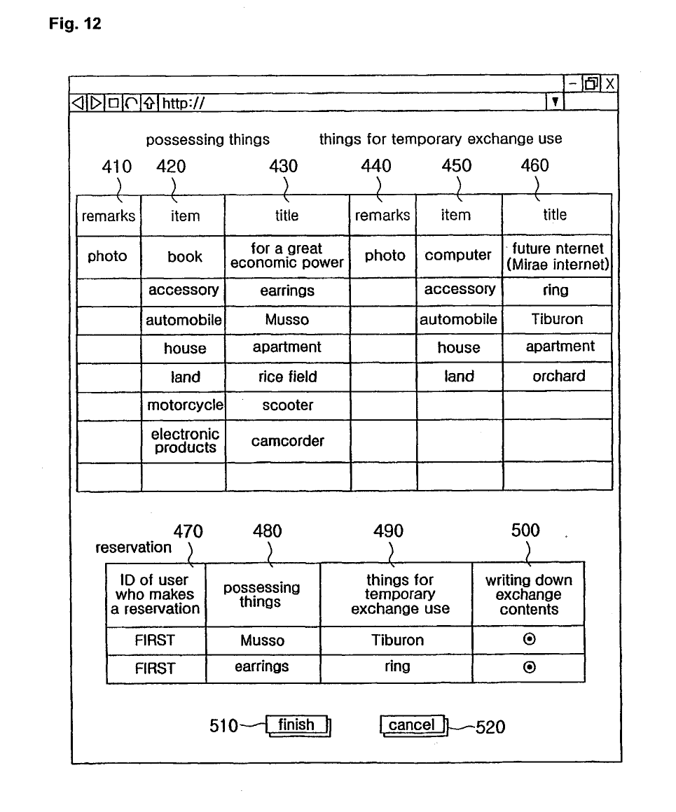

FIG. 12 is a drawing of a web page for showing a list that users register thereto according to an embodiment of the present invention.

Referring to FIG. 12, the information that the user 30 inputs in FIG. 11 is registered to ‘my list’ and a list of the articles 400 that the user 30 presently has and a list of the articles 410 that the user 30 wants to use by the temporary exchange are separately displayed. Among items, the ‘remarks’ items 420 and 450 are to indicate if the photo is appended or not and the items of articles 430 and 460 and titles of articles 440 and 470 are displayed. In addition, when the user clicks each item, the concrete and detailed information about each item is provided. The user 30 who wants to exchange articles may reserve the articles in the ‘reservation’ part 480 on a lower portion of the web page. The user 30 should input his/her ID 490, the articles 500 that he/she has, the articles 510 that he/she wants to temporarily exchange, and the writing down exchange contents 520 in the reservation 480. When the list making is completed, the user may choose ‘finish’ 530 or ‘cancel’ 540.

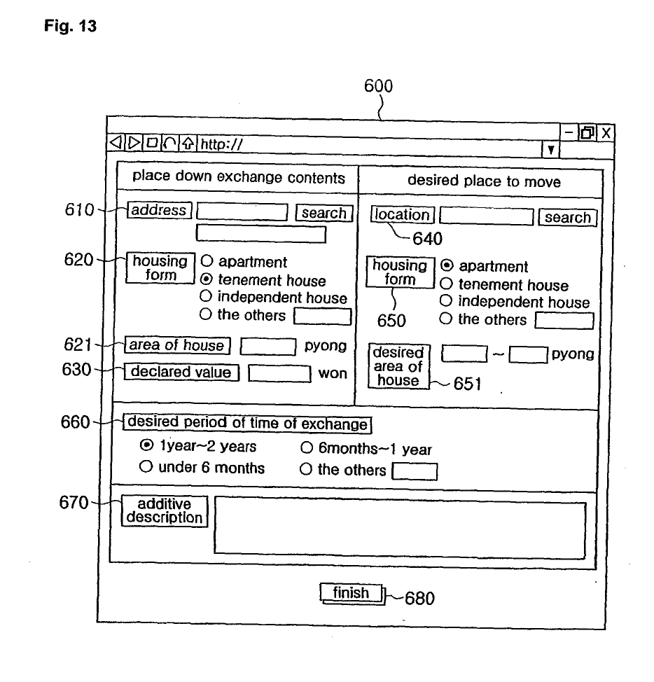

FIG. 13 is a drawing of a web page for showing an application for housing service according to an embodiment of the present invention.

Referring to FIG. 13, the user 30 accesses the server of the business proprietor through the network 20 and inputs the required information on an web page 600 made by the service business proprietor to fill out the application for the house exchange service. On the web page 600, the user 30 inputs the address 610 of the house presently belonging to him/her, selects the housing form 620, and writes down the area 621 of the house and the declared value 630. On the right portion of the web page 600, the user 30 writes down the desired location of the house 640, selects the desired housing form 650, and writes down the desired area 651. Then, the user 30 selects the desired period of time 650. Finally, the user 30 writes down the additive comment about the house or the transaction in a blank for additive comment 670 if any and finishes the fill-out 680.

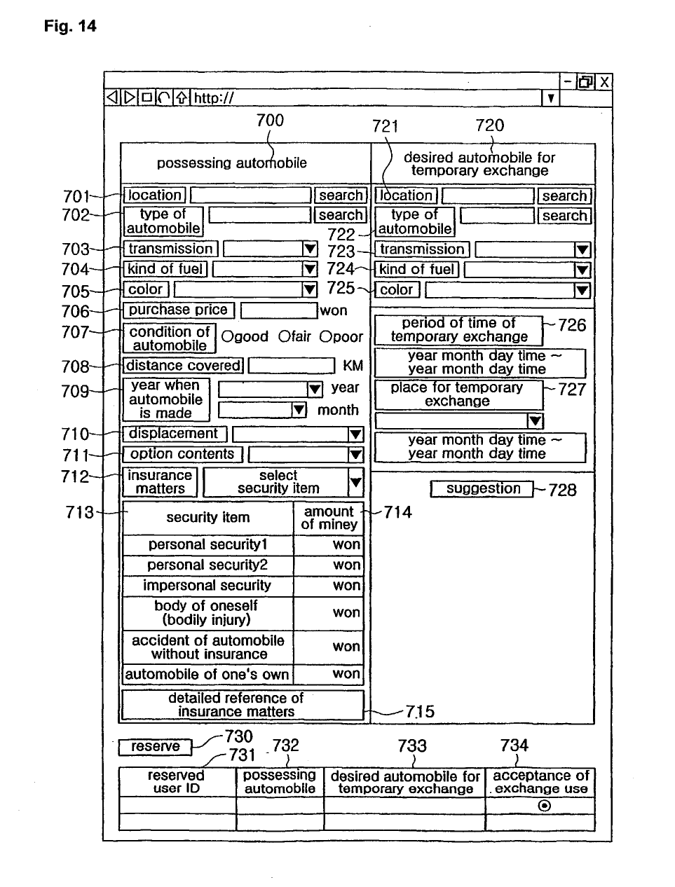

FIG. 14 is a drawing of a web page for showing an application for automobile according to an embodiment of the present invention.

Referring to FIG. 14, the user logs in the web server and requests the exchange for the use of the automobile temporarily exchanged and notices the acceptance or the refusal to the another user who requests the exchange.

For the temporary exchange of the automobiles, the user should input the detailed information about the automobile belonging to the user. As the list and the detailed information of the automobile belonging to the user, the location 710, the type of the automobile 702, the transmission 703, the kind of fuel 704, the color 705, the purchase price 706, the condition of the automobile 707, the distance covered 708, the year when the automobile is made 709, the displacement 710, the option contents 711, etc. may be mentioned. In addition, if the automobile is covered by insurance or not 712 may be added to the information since it is the important matter on exchanging the automobile. For example of the security items for the automobile insurance 713, personal security 1, personal security 2, impersonal security, body of oneself (bodily injury), accident of automobile without insurance, automobile of one's own, etc may be mentioned. In addition, the amount of money that can be compensated according to the amounts of money 714 corresponding to the items should be also input. The detailed reference whether the automobile is covered by insurance or not 715 allows the user to know the insurant's driving habit. The detailed reference 715 may include the accident contents, the violation of traffic regulations, black marks, etc. of the driver and this information may be obtained by cooperation or business sharing with insurance companies having public confidence, the Korean insurance development institute, the Korean non life insurance association, the police agency, the financial supervisory service, and various kinds of companies related to finance. It is preferable not to provide the personal information and the vehicle registration number of the user to other user 30 for preventing the drain of personal information of the user 30.

In addition, in the portion of the automobile that the user wants to use by temporary exchange, the user 30 should input the location 721, the type of the automobile 722, the transmission 723, the kind of fuel 724, the color 725, etc., and then, the period of time of the exchange use 726. The place for the exchange 727 means a things deposit center 80 where the users would meet on temporarily exchanging the automobiles. Through the ‘suggestion’, the other party of users may give a suggestion about the period of time of the exchange use or the place for the exchange.

When the user 30 clicks the ID of user who makes a reservation after certifying the ID of user who makes a reservation 731, the automobile holding 732, and the automobile that the user 30 wants to use by temporary exchange 733, the user 30 may see the information and the insurance contents of the automobile of the user who makes a reservation. The user 30 certifies the contents and when the exchange condition satisfies the user 30, he/she lets the contract to be made by clicking the acceptance of exchange 734.

In case of the temporary exchange of the automobile, to compare the automobile's conditions before and after exchanging use, the process of photographing and storing by using optical devices such as camera or camcorder, the process of examining and storing by using a paper work, the process of storing photographs by scanning, and the process of examining and verifying the automobile by a professional evaluator and using evaluating device for checking the condition and estimating a cost are required.

The evaluation contents by photographing the exterior and the interior of the automobile made out by the processes as mentioned above are as shown in table 1.

TABLE 1

| Photographed | | | |
|---|---|---|---|
| portion | Condition | Evaluation contents | Photograph |
| Front portion | scratched | Scratched about 5 cm | |
| | | in the shape of | |
| | | horizontal line | |
| Left lateral | No change | | |
| portion | | | |
| Right lateral | distorted | Distorted about 3 cm | |
| portion | | due to the impact | |
| Backside | No change | | |
| portion | | | |
| Top portion | No change | | |
| Bottom | No change | | |
| portion | | | |
| Dashboard | No change | | |
| Driver seat | No change | | |
| Assistant seat | No change | | |
| Rear seat | No change | | |
| Sheet | No change | | |
| Ceiling | stained | Stained by coffee | |
| Glass | No change | | |

Referring to table 1, all the part related to the automobile such as front portion, left lateral portion, right lateral portion, backside portion, top portion, bottom portion, dashboard, driver seat, assistant seat, rear seat, sheet, ceiling, glass, etc. may be included in the portion to be photographed. The condition may be indicated by scratched, distorted, aperture, rusted, exchanged, etc. The evaluation contents blanks is where to register the evaluation contents of each portion photographed in detail.

In addition, the evaluation contents of each device of the automobile are as shown in table 2.

TABLE 2

| Evaluation | | | |
|---|---|---|---|
| item | Condition | Evaluation contents | Photograph |
| Engine | Oil leakage | Oil is leaked by | |
| system | | gasket trouble, | |
| Power | | gasket exchange | |
| | | is required | |
| transmission | No change | | |
| device | | | |
| Charging | No change | | |
| device | | | |
| Exhausting | No change | | |
| device | | | |
| Air | | | |
| conditioning | No change | | |
| system | | | |
| Suspension | No change | | |
| system | | | |
| Cooling | No change | | |
| system | | | |
| Brake system | Abrasion of | Brake operation | |
| | brake pad | is not good due to | |
| | | the abrasion of brake | |
| | | pad, exchange is required | |

Referring to table 2, devices forming the automobile such as engine system, power transmission device, charging device, exhausting device, air conditioning system, suspension system, cooling system, brake system, etc. may be included in the evaluation items. The condition shows the condition of each item and the evaluation contents blanks is where to describe and register the detailed condition of the evaluation items.

In case of exchanging automobiles, the problem of compensation for damages as to by the recorded portions by photographing may be settled on the basis of photographs. However, the evaluation contents of engine or other devices may be vague. In this case, the business proprietor 10 judges the conditions of the automobile on the basis of the evaluation contents and when the business proprietor 10 judges that the evaluation contents after exchanging use is considerably different from that before exchanging use, it is preferable to claim compensation from the user 30.

Additionally, the detailed evaluation contents about sections and gadgets of the automobile may be made out as shown in table 3.

TABLE 3

| | Evaluation | | Evaluation |
|---|---|---|---|
| Evaluation items | contents | Evaluation items | contents |
| Noise and | Good | Glass | Nothing wrong |
| oscillation of | | | |
| engine | | | |
| Engine oil | Good | Fog lamp | Nothing wrong |
| Number of | A little | Light | Nothing wrong |
| rotations | bit high | | |
| of idling | | | |
| Water pump | Good | Turn signal lamp | Nothing wrong |
| Battery | Good | Tail lamp | Exchange is |
| | | | required |
| Transmission | Exchange is | Brake lamp | Nothing wrong |
| oil | required | | |
| Anti-freezing | Good | Antenna | Nothing wrong |
| solution | | | |
| Generator | Bad | Side mirror | Nothing wrong |
| Abrasion condition | 20% | Window brush | Exchange is |
| of brake | | | required |
| Power steering | Nothing wrong | Power window | Nothing wrong |
| Horn | Normal | Heater | Nothing wrong |
| Car stereo system | Normal | Air-conditioner | Gas injection |
| and CD player | | | is required |
| Power door lock | Nothing wrong | Hot wire | Nothing wrong |

Referring to table 3, the evaluation contents of the items may be indicated as good, bad, nothing wrong, abrasion rate, etc. In addition, the process estimating a cost of the automobile should be included to settle the problem of damage compensation after exchanging use.

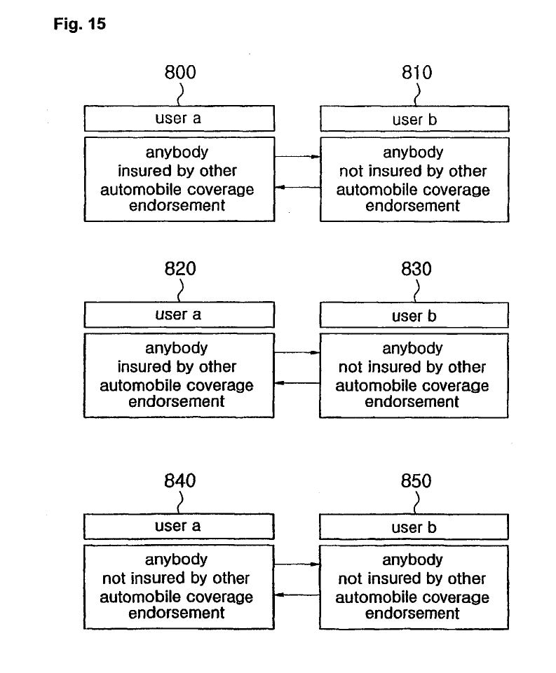

FIG. 15 is a diagram showing insurance matters required for exchange of automobiles according to an embodiment of the present invention.

FIG. 15 shows a method of exchanging automobiles within the limits of the possibility of compensation by the automobile insurance.

As a method of exchanging automobiles, a method of exchanging the same according to the mutual agreement between the users 30 and a method of exchanging the same within the limits of the possibility of compensation by the automobile insurance may be mentioned. The former method may be possible for anybody who wants the exchange use when the other party of users accepts the exchange use, but according to the latter method, the exchange use is made within the limits of the possibility of compensation by way of precaution against automobile accident that could be occurred. Accordingly, the latter method is safer than the former.

In the case of the exchange use of the user a 30a and the user b 30b, according to the insurance contents of the user a 30a, the extent of driver is ‘anybody’ and the automobile of the user a 30a is insured by ‘other automobile coverage endorsement’ 800 and according to the insurance contents of the user b 30b, the extent of driver is ‘anybody’ and the automobile of the user b 30b is not insured by ‘other automobile coverage endorsement’ 810. In this case, when the user a 30a drives the automobile of the user b 30b, the user a 30a may be compensated by the insurance of the user b 30b and the compensation for the voluntary insurance not bought of the user b 30b may be made by the ‘other automobile coverage endorsement’ of the user a 30a. Further, when the user b 30b drives the automobile of the user a 30a, the user b 30b may be compensated by the insurance of the user a 30a.

In another case, according to the insurance contents of the user a 30a, the extent of driver is ‘anybody’ and the automobile of the user a 30a is insured by ‘other automobile coverage endorsement’ 820 and according to the insurance contents of the user b 30b, the extent of driver is ‘only family’ and the automobile of the user b 30b is insured by ‘other automobile coverage endorsement’ 830. In this case, when the user a 30a drives the automobile of the user b 30b, the user a 30a may by compensated by the ‘other automobile coverage endorsement’ of the user a 30a. Further, when the user b 30b drives the automobile of the user a 30a, the user b 30b may be compensated on the basis of ‘anybody’ of the insurance of the user a 30a and when the compensation amount is over the amount of insurance of the user a 30a, the user b 30b may be compensated for the excess amount by the ‘other automobile coverage endorsement’ of the user b 30b. In the case mentioned above, when the automobile of the user b 30b is not insured by ‘other automobile coverage endorsement’, the compensation is made only by ‘anybody’ of the insurance of the user a 30a.

In another case, according to the insurance contents of the user a 30a, the extent of driver is ‘only family’ and the automobile of the user a 30a is insured by ‘other automobile coverage endorsement’ 840 and according to the insurance contents of the user b 30b, the extent of driver is ‘only family’ and the automobile of the user b 30b is insured by ‘other automobile coverage endorsement’ 850. In this case, when the user a 30a drives the automobile of the user b 30b, the user a 30a may by compensated by the ‘other automobile coverage endorsement’ of the user a 30a. Further, when the user b 30b drives the automobile of the user a 30a, the user b 30b may be compensated by the ‘other automobile coverage endorsement’ of the user b 30b.

When the compensation for the accident during the exchange use is made by the insurance of the other party, the premiums of the other party may be raised. In this case, it is preferable that the user who causes the accident pays the raised amount of premiums. Further, when the fine due to the violation of traffic regulations is charged the other party, it is preferable that the user who actually drives the automobile pays the fine.

Consequently, as methods of covering accidents by the insurance, a method of covering by the insurance of oneself, a method of covering by the insurance of the other party, a method of covering by the insurance of the other party and additionally covering by the insurance of oneself when the amount is excess, and a method of covering by the insurance of oneself and additionally covering by the insurance of the other party when the amount is excess may be mentioned.

Among those, the best method is the one of covering by the insurance of oneself, so, a new insurance corresponding such conditions is required.

Further, when the exchange use is made between the users who live in areas not far from each other, they may use the nearest things deposit center 80 and when the exchange use is made between the users who live in areas far from each other or different countries, a first user deposits the automobile in the things deposit center 80 of the area where the first user lives then a second user exchanges the automobiles in the things deposit center 80 of the area where the second user lives and returns the used automobile to the same place.

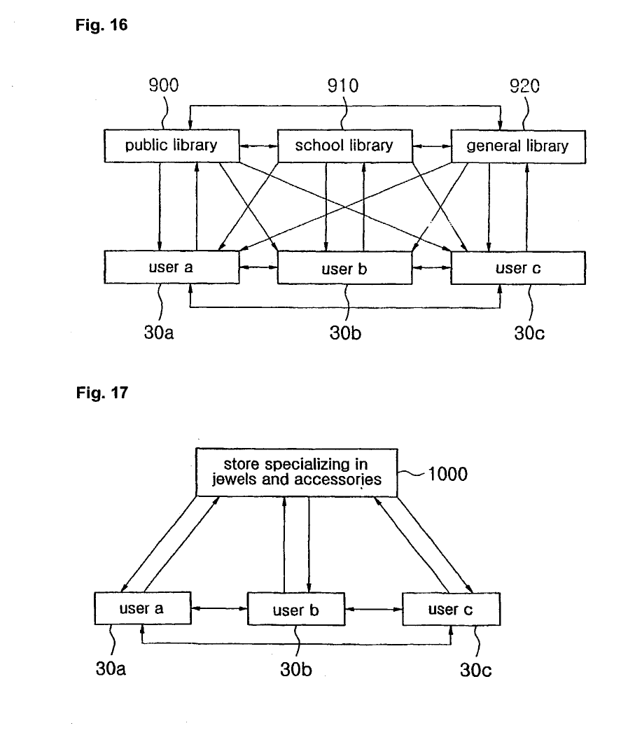

FIG. 16 is a structural diagram of service concerned with books according to an embodiment of the present invention.

Referring to FIG. 16, the users 30a, 30b, and 30c donates, entrusts, or sells books to libraries 900, 910, and 920 and the libraries 900, 910, and 920 provide service of the exchange use or the loan use of books to the users 30a, 30b, and 30c who deposit books.

For example of the exchange use of books, the followings may be mentioned: the user a 30a deposits books in the public library and the user b 30b deposits books in the school library. According to the mutual agreement of the user a and b 30a and 30b, the user a 30a may borrow the books of the user b 30b from the school library 910 and the user b 30b may borrow the books of the user a 30a from the public library 900.

That is, the libraries 900, 910, and 920 may provide the book exchange service under the acceptance of the users 30a, 30b, and 30c. In another way, the users 30 may exchange books with each other in person not using the libraries 900, 910, and 920.

The books that the users 30a, 30b, and 30c deposit may be borrowed by any one of the users 30, so, it means that the share of use of books is possible.

The concrete example of the loan use is as follows. The users 30a, 30b, and 30c donate, entrust, or sell books to the libraries 900, 910, and 920. The libraries 900, 910, and 920 who receive the authority of management of books from the users 30 loan books to members or others who are not members. Each of the users 30 may search books that he/she wants and borrow the same from the nearest library among the libraries 900, 910, and 920.

The libraries may have advantages of increasing the number of books, saving the cost for purchasing books, and increasing the use of library.

It is reasonable that the place for exchanging or loaning books is not limited to the library 900, 910, and 920 and may be any place where the exchange or loan of books is possible.

Additionally, the business proprietor 10 arranges the books by fields, kinds, and subjects and allows a user to have priority to loan books that suit the user's taste.

For example, the proprietor 10 arranges the books by items such as book of fiction, comic book, magazine, collection of poem, professional technical book, children's book, book for examination, reference book, book for various qualifying examinations, etc and gives the user 30 priority for loaning the books that correspond to the kinds of books that the user deposits or the user's 30 personal information. The proprietor 10 may use a method of loaning the books arranged by fields, kinds, subjects, and years only or a method of loaning the books regardless of fields, kinds, subjects, and years.

Further, when the user deposits the latest books or best-selling ones, the user may receive the priority for loaning the latest books or best-selling books.

Depositing books in the library should be national campaign and the benefit should be given to who deposits books in the library. Everyone has books more than one and books not to be read and occupying space of room. The libraries up to now lend books for nothing, but from now on, users depositing books in the library should receive the benefit of loaning books. If the library does not lend books to who does not deposit books in library, users may deposit books in a library (deposit center or loan center). It may contribute to the development of culture of using library and save the cost for purchasing books. When the user depositing books graduates from school or moves to another area, the library may transfer the books of the user to a library of the area where the user moves.

FIG. 17 is a structural diagram of service concerned with jewels and accessories.

Referring to FIG. 17, the users 30 donate, entrust, or sell jewels or accessories belonging to the users 30 to stores 1000 specializing in jewels and accessories and the stores 1000 provide service of the exchange use or the loan use of jewels or accessories to the users 30.

The users 30 may exchange the jewels or accessories with each other in person not using the stores 1000. In this case, the users 30 may make a financial profit. On the contrary, in the case of using the stores 1000, the exchange or loan with another users may be possible. In this case, the stores 1000 may save the cost for purchasing things since the stores 1000 loan deposited things.

As the case of libraries, the stores may be replaced with any places where the exchange or loan of things is possible.

The methods of exchanging or loaning things mentioned above referring to FIGS. 13-17 are possible through internet using network 20, conventional personal visit, telephone, communication system, etc.

According to the methods of exchanging or loaning things mentioned above, the exchange use or the loan use carries more than one conditions. The user 30 finds a person who has things that the user 30 needs or things by search, then, makes a reservation for the things or requests the exchange use. When the exchange condition is difficult or there is any trouble to communication with the other party, the user 30 requests the exchange use or the loan use to the business proprietor. The other party of users 30 or the business proprietor 10 should answer to the user 30 who requests the exchange use or the loan use. The business proprietor 10 should prepare the things deposit center 80 where the users may exchange, lend, or borrow things and the users 30 donate, entrust, or sell things to the things deposit center 80. The business proprietor 10 running the things deposit center 80 stores the personal information of the users 30, the information of the users' articles, or the information of insurance in the database linked to the web server.

In addition, though it is not described in drawings, when the things are the exhibits of museum or art gallery, the exhibits may temporarily exchanged and displayed for users to see the exhibits without moving to another area.

The service of exchange use or loan use may be applied to the land. When the user 30 who does farming has a land not suitable for crops that he/she wants to cultivate, it costs much to change or improve the soil. In this case, the user may exchange the land with the one suitable for crops and it may make a financial profit.

Additionally, the service may be applied to machines or medical instruments. In the case of medical instruments, such a service may be more effective since it cost so much to prepare the medical instruments even when the same is temporarily used.

Consequently, the service of exchange use or loan use may be applied to all the valuable things. The inventive service may be applied to the conventional service business using newspaper, practical advertisement paper, etc.

According to an aspect of the present invention, since the service business proprietor intermediates temporary exchange of things that the users wants to use, the users may use things without cost for purchasing things. In addition, since the user may use things that the users easily get tired of for a short period of time, this service may satisfy the users' desire of various things.

According to another aspect of the present invention, since the users may deposit things occupying space to loan the same, this service provides the users advantages that the users may get more space and a new value of things may be generated by re-using the things.

According to another aspect of the present invention, when any accident or violation of traffic regulations is occurred in the middle of the exchange use of automobiles, the user or the business proprietor may apply sanctions against the other user that occurs the accident or violation of traffic regulations. In this case, the user drives carefully to prevent any accident or violation of traffic regulations and the number of automobiles not insured may be reduced since automobiles not insured may be excluded from the exchange use.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A business method for intermediating temporary exchange of things using the network comprising steps:
(a) building a database linked to a web server with personal information of users and information about things to be exchanged having fixed period of time of exchange;
(b) searching the information of things to be exchanged input by the users for things having corresponding condition;
(c) intermediating the exchange of things for the stipulated time under the acceptance of users; and
(d) certifying whether the things return or not after the stipulated time by a business proprietor.

2. The method according to claim 1, wherein said (b) step further comprises a step informing users having things coinciding exchange conditions with each other of the result.

3. The method according to claim 1, wherein said (b) step further comprises steps said user's finding things that he/she wants by searching the database of said business proprietor and requesting the exchange of things to another user.

4. The method according to claim 1, wherein, when the exchange is made among three users A, B, and C, the user A lends things to the user B, the user B lends things to the user C, and the user C lends things to the user A.

5. The method according to claim 4, wherein, when the users A and B have a confidence relationship, the user A lends his/her things to the user C and the user C lends his/her things to the user B.

6. The method according to claim 1, wherein said business proprietor deposits things of the users in a predetermined place and makes out examination data of the conditions of things to be exchanged to allow the exchange use or the share of use.

7. The method according to claim 1, wherein said (d) step further comprising steps calculating the amount of damages by comparing the conditions before and after exchange of things and charging the user the amount of damages.

8. The method according to claim 1, wherein said things to be exchanged movable property or real estate.

9. The method according to claim 8, wherein said things to be exchanged belongs to one item or more selected among various kinds of valuable movable property or real estate such as housings, lands, automobiles, books, jewels, accessories, exhibits, machines, medical instruments, electronic products, programs including software, membership ticket, utilization ticket, etc.

10. The method according to claim 1, wherein said service of exchange use is made between users or between user and the business proprietor with or without compensation.

11. The method according to claim 1, wherein, when said service of exchange use is provided with compensation, the settlement method is one or more selected among cash, credit card, depositing without bankbook, electronic settlement, cyber money, and member point.

12. The method according to claim 1, wherein comparing item to exchanging things is one or more selected among things that the users want to exchange, evaluation price, the desired period of time of exchange, and condition that the users desire.

13. The method according to claim 1, wherein said service business proprietor provides a new insurance related to temporary exchange without compensation through the insurance company when the business proprietor and the user make a contract with each other.

14. The method according to claim 1, wherein the database of the information of the users' things that said service business proprietor builds on the web comprises one or more selected among the information of things to be exchanged, the information of things in progress of exchange, the information of things to be returned, and the information of insurance of things.

15. The method according to claim 1, wherein said insurance company takes the main part of this business and provide said service.

16. A computer readable medium having computer executable instruction for performing the method according to any one of claim 1 to 15.

17. A business method for intermediating temporary exchange of things using the network comprising steps:
(a) building a database linked to a web server with personal information of users and information about things to be exchanged;
(b) receiving things of said users by way of donation, trust, or selling and depositing the same in a predetermined place;
(c) lending said thing to another user for the stipulated time; and
(d) returning said thing from said user who borrows the thing and calculating the amount of damages by checking the condition of thing by a business proprietor.

18. The method according to claim 17, wherein said things to be loaned is movable property or real estate.

19. The method according to claim 18, wherein said things to be loaned belongs to one item or more selected among various kinds of valuable movable property or real estate such as housings, lands, automobiles, books, jewels, accessories, exhibits, machines, medical instruments, electronic products, programs including software, membership ticket, utilization ticket, etc.

20. The method according to claim 17, wherein said service of loan use is made between users or between user and the business proprietor with or without compensation.

21. The method according to claim 20, wherein, when said service of loan use is provided with compensation, the settlement method is one or more selected among cash, credit card, depositing without bankbook, electronic settlement, cyber money, and member point.

22. A computer readable medium having computer executable instruction for performing the method according to any one of claim 17 to 21.
